(19) United States
(12) Patent Application Publication
(10) Pub. No.: US 2009/0134089 A1
(43) Pub. Date: May 28, 2009

(54) Fish tank filter

(75) Inventors: Karmin L. Olson, Kansas City, MO (US); Paul Henry, Lee's Summit, MO (US)

Correspondence Address: NIXON & VANDERHYE P.C., 901 NORTH GLEBE ROAD, 11TH FLOOR, ARLINGTON, VA, 22203, US

(73) Assignee: General Electric Company, Schenectady, NY (US)

(21) Appl. No.: 11/987,158

(22) Filed: Nov. 28, 2007

(51) Int. Cl. B01D 71/26; A01K 63/04

(52) U.S. Cl. 210/500.36

(57) ABSTRACT

A filter for use in filtering and treating contaminated water in an aquarium tank includes a filter bag for receiving a continuous supply of contaminated aquarium water pumped under a predetermined pressure into the interior of the bag. The wall of the bag is composed of a porous filter membrane formed of a laminate of a ePTFE membrane and polypropylene needlefelt material.

### BACKGROUND OF THE INVENTION

This invention relates to an aquarium or fish tank filter composed of a hydrophilic PTFE membrane laminate, with controlled pore size for improved filtration performance.

It is generally required that contaminated aquarium water be filtered and decontaminated before it is recirculated into the aquarium tank (also sometimes referred to herein as a fish tank). Some traditional aquarium filters use gravity filtration with an activated carbon filter that must be replaced periodically. An example of a gravity filter for aquarium use is disclosed in U.S. Pat. No. 4,807,565.

It is also known to provide a filter assembly for an aquarium in the form of an enclosed filter bag into which a continuous supply of contaminated aquarium water is introduced under a predetermined pressure. The filter bag wall is a membrane composed of a synthetic resin such as unbranded, garnetted, bonded and lofted polyester fiberfill. A filter configuration of this type is disclosed in U.S. Pat. No. 4,622,148. The patent also indicates that the membrane can be in the form of interwoven sheet material characterized by elasticity or displaceability upon application of water pressure.

There remains a need for aquarium or fish tank filters utilizing membranes with improved filtration performance.

### BRIEF DESCRIPTION OF THE INVENTION

In accordance with one aspect, the present invention relates to filter for use in filtering and treating contaminated water in an aquarium or fish tank comprising:

a filter bag for receiving a continuous supply of contaminated aquarium water pumped under a predetermined pressure into the interior of said bag;

the wall of said bag being comprised at least in part of a two-layer laminate, one layer of said laminate comprising a PTFE membrane.

In another aspect, the invention relates to a filter bag for receiving a continuous supply of contaminated aquarium water pumped under a predetermined pressure into the interior of said bag;

the wall of said bag being comprised at least in part of a porous two-layer laminate, one layer of said laminate comprising an ePTFE membrane, and the other layer comprising a polypropylene material; and

wherein said ePTFE membrane has a coating layer with hydrophilic properties.

The invention will now be described in detail in connection with the drawings identified below.

### BRIEF DESCRIPTION OF THE DRAWINGS

FIG. 1 is a cross-sectional view of a known membrane structure utilized as an aquarium or a fish tank filter;

FIG. 2 is an exploded view of a conventional aquarium or fish tank filter assembly employing the membrane shown in FIG. 1;

FIG. 3 is an enlarged schematic sectional view of an exemplary embodiment of a composite filter membrane in accordance with this disclosure; and

FIG. 4 is an enlarged schematic representation of the membrane component of the composite article shown in FIG. 3.

### DETAILED DESCRIPTION OF THE INVENTION

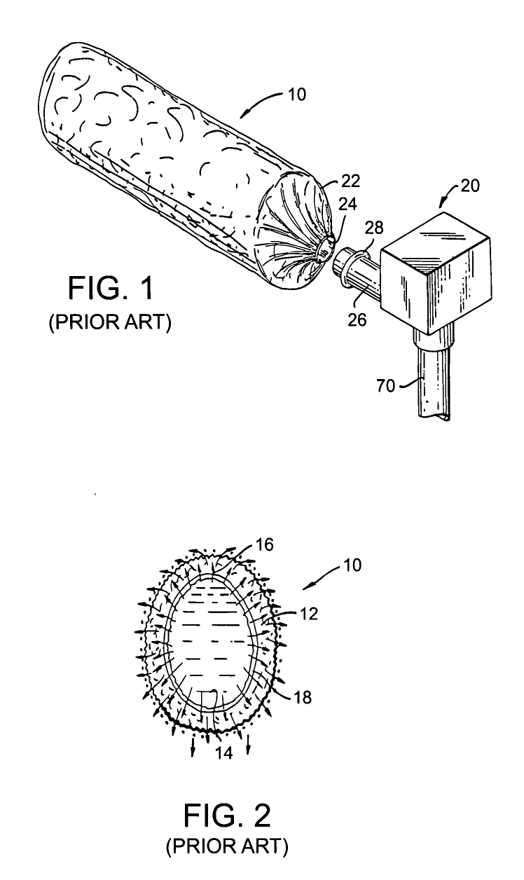

With reference to FIGS. 1 and 2, a filter assembly as described in U.S. Pat. No. 4,622,148 is constructed in the form of an elongated filter bag 10. The wall (or walls) 12 that defines the bag is formed of a pressure-displaceable, closely and preferably randomly disposed, spaced stretchable filamentary material, described in greater detail below.

In use, aquarium water is pumped into the interior of the bag receptacle by, for example, a centrifugal or other suitable water pump. The density of the walls of the bag in this conventional construction is such that the water will initially flow freely, and then seep or ooze through the walls as the pores and passages begin to clog. Pressurization of the water in the bag increases progressively due to this clogging and forces the receptacle water to distend and expand in a ballooning effect. The filamentary material forming the membrane structure is displaced under the increased pressure causing the interstices to enlarge so that the water continues to flow.

As the water passes outward through the walls as shown in arrows 16, solid waste and other contaminants from the aquarium water is retained internally in the bag as shown at 18.

A supply source such as a centrifugal pumping unit 20 may be employed along with the filter bag 10 for supplying contaminated water from the aquarium tank into the bag. The filter bag itself is shown to be constructed in an elongated shape which, when filled with water, can be disposed horizontally as shown. By retaining the bag in horizontal position, water pressure is said to be evenly distributed in the filter bag, causing uniform water distribution through the length of the bag and consequently, a more even distribution of contaminants within the bag. At one end 22 of the enclosed bag 10, there is provided an opening or mouth 24 in the form of a port or mouth through which the contaminated water is fed. The mouth 24 receives an outlet 26 of the supply means 20. A suitable collar 28 can be placed around the outlet 26 so as to securely engage the mouth 24.

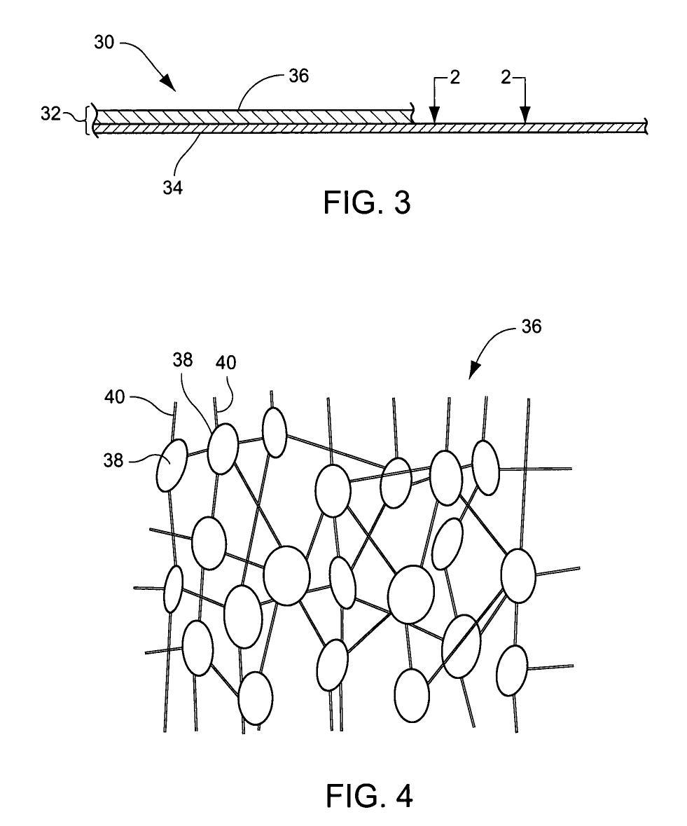

In an exemplary and non-limiting embodiment of the present invention, a filter bag 30 generally similar to the bag 10 is employed, but the composition of the bag wall 32 or membrane is changed. Preferably, the bag wall 32, as shown in FIG. 3, is a hydrophilic PTFE membrane laminate, with controlled pore size for improved filtration performance. The composite laminate may be as described in commonly-owned U.S. Published Application No. 2007/0075014A1, incorporated herein by reference. More specifically, the bag wall 32 is a composite article that includes a base material 34 laminated with a porous membrane 36. The base material 34 may be of any type of material that meets performance and/or other criteria established for an application in which the composite article will be used as an aquarium or fish tank filter. For example, the base material 44 may include polypropylene, polyethylene, polyester, acrylic, polyphenylene sulfide (PPS), aramid, polyimide, glass, and/or polytetrafluoroethylene (PTFE). The base material 44 may be in the form of a woven material and/or non-woven material, such as but not limited to, needlefelt, spunbound, extruded mesh, dry-lattice, cast film and/or hydro-entangled materials. In a preferred but non-limiting example, the base material is a woven or non-woven polypropylene needlefelt.

As shown in FIG. 4, the membrane component 36 of the laminate is porous, and in some embodiments microporous, with a three-dimensional matrix or lattice type structure of a plurality of nodes 38 interconnected by a plurality of fibrils 40. Membrane 36 is preferably made from a material, such as, but not limited to, expanded polytetrafluoroethylene (ePTFE) and/or a PTFE fabric. A preferred pore size for the membrane 36 is from 0.2 to 0.8 microns, but the porosity may be adjusted as needed.

Base material 34 and membrane 36 may be laminated together using any suitable process, any suitable parameters, and using any suitable means. For example, and although base material 34 and membrane 36 may be laminated together at any temperature, in some embodiments, base material 34 and membrane 36 are laminated together using heat at a temperature of greater than about 300° F. In one exemplary embodiment, base material 34 and membrane 36 are laminated together at a temperature of between about 680° F. and about 700° F. For example, in some embodiments wherein base material 34 is ePTFE, base material 34 and membrane 36 are laminated together using heat at a temperature of about 690° F. However, in some embodiments base material 34 and membrane 36 are laminated together using heat at a temperature of less than about 300° F. For example, in some embodiments wherein base material 34 is polyethylene, base material 34 and membrane 36 are laminated together using heat at a temperature of about 250° F. In some embodiments, and for example, base material 34 and membrane 36 are laminated together using an adhesive applied between membrane 16 and base material 14.

In order to enhance the hydrophilic properties of the laminate, a hydrophilic coating layer is applied over the membrane. The coating composition and method of applying the coating to the membrane may be as described in the '014 published application. Briefly, the coating layer is a hydrophilic coating that may enhance hydrophilic properties of membrane 36. For example, coating layer may increase the surface tension and/or energy of membrane 36 so at least some aqueous solutions and/or other polar solvents are capable of wetting membrane 36 and passing through the membrane pores. Selecting a coating layer with a predetermined surface energy and/or tension may therefore allow selective flow through membrane 36 (and through composite bag 30), of some aqueous solutions and/or other polar solvents.

The coating layer includes coalesced solids having hydrophilic properties. Although the coating layer may include other hydrophilic solids, in some embodiments the coating layer is formed from a coating composition including organofunctional siloxane solids and/or polyether urethane polymer solids.

The hydrophilic solids are diluted in one or more suitable solvents to form the coating composition that will form the coating layer. Although other solvents may be used, suitable solvents may include, but are not limited to, water, ethanol, isopropyl alcohol (IPA), acetone, methanol, n-propanol, n-butanol, N—N-dimethylformamide, methyl ethyl ketone and water soluble e- and p-series glycol ethers. Moreover, although the solvents may have other surface tensions, in some embodiments, the coating composition includes a solvent having a surface tension of less than about 31 dynes per centimeter.

Although the coating composition may include other amounts, in some embodiments, the composition forming the coating layer includes an amount of hydrophilic solids in the range of about 0.1 wt % to about 10 wt % based on total weight of the coating composition.

The coating composition can be applied to membrane 36 using any suitable process, such as, but not limited to, roll-coating, immersion (dipping), and/or spraying. In the exemplary embodiment, to apply the coating composition that forms coating layer, the laminated base material 34 and membrane 36 are directed over a roller that is immersed within a reservoir containing the coating composition as described in the '014 Publication.

Using ePTFE as the membrane material is advantageous in that the filtering occurs at the surface, rather than deep within the material. This allows the filter to be easily cleaned and reused, unlike other materials that require replacement. In this regard, an activated carbon layer could, if desired, be added between the base material and the membrane to filter out additional impurities. This option would, however, likely preclude cleaning and reuse of the filter bag.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A filter for use in filtering and treating contaminated water in an aquarium or fish tank comprising:
a filter bag for receiving a continuous supply of contaminated aquarium water pumped under a predetermined pressure into the interior of said bag;
the wall of said bag being comprised at least in part of a porous two-layer laminate, one layer of said laminate comprising a PTFE membrane.

2. The filter of claim 1 wherein said PTFE membrane is an ePTFE membrane.

3. The filter of claim 2 wherein the other layer of said laminate comprises polypropylene.

4. The filter of claim 3 wherein said other layer comprises a polypropylene needlefelt material.

5. The filter of claim 2 wherein said ePTFE membrane has a coating layer with hydrophilic properties.

6. The filter of claim 2 wherein said ePTFE membrane is on an interior side of said filter bag.

7. The filter of claim 4 wherein said ePTFE membrane is on an interior side of said filter bag.

8. The filter of claim 1 wherein said laminate has a pore size of from about 0.2 to about 0.8 microns.

9. The filter of claim 5 wherein a coating layer formed on at least a portion of said porous membrane, said coating layer comprising at least one of an organofunctional siloxane and a polyether urethane polymer.

10. The filter of claim 9 wherein said coating composition comprises between about 1.0 and about 3.0 wt % solids based on the total weight of said coating composition.

11. A filter for use in filtering and treating contaminated water in an aquarium or fish tank comprising:
a filter bag for receiving a continuous supply of contaminated aquarium water pumped under a predetermined pressure into the interior of said bag;
the wall of said bag being comprised at least in part of a porous two-layer laminate, one layer of said laminate comprising an ePTFE membrane, and the other layer comprising a polypropylene material; and
wherein said ePTFE membrane has a coating layer with hydrophilic properties.

12. The filter of claim 11 wherein said ePTFE membrane is on an interior side of said filter bag.

13. The filter of claim 11 wherein said laminate has a pore size of from about 0.2 to about 0.8 microns.

14. The filter of claim 11 wherein a coating layer formed on at least a portion of said porous membrane, said and comprises at least one of an organofunctional siloxane and a polyether urethane polymer.

15. The filter of claim 14 wherein said coating composition comprises between about 1.0 and about 3.0 wt % solids based on the total weight of said coating composition.
